(19) United States
(12) Patent Application Publication
(10) Pub. No.: US 2026/0319929 A1
(43) Pub. Date: Oct. 15, 2026

(54) TEST SUITE EXCLUSION USING ARTIFICIAL INTELLIGENCE

(71) Applicant: Black Duck Software, Inc., Burlington, MA (US)

(72) Inventor: Raymond John KELLY, Watkinsville, GA (US)

(21) Appl. No.: 19/176,415

(22) Filed: Apr. 11, 2025

(51) Int. Cl. G06F 11/3668

(52) U.S. Cl. CPC G06F 11/3688

(57) ABSTRACT

Described herein is a system for executing test suites. A computer system includes one or more memories and one or more processors communicatively coupled to the one or more memories. The one or more processors, individually or collectively, perform an operation that includes transmitting a message to a server and receiving, from the server, a response to the message. The operation also includes determining, by analyzing the response using a machine learning model, that a platform is unused by the server and based on the platform is unused, executing, against the server, a test suite except a portion of the test suite for the platform.

### TECHNICAL FIELD

The present disclosure relates to executing test suites (e.g., to detect security risks).

### BACKGROUND

Test suites may be executed against servers (e.g., web servers) to detect security risks on those servers. The test suites may include portions that target specific systems (e.g., specific platforms, services, plugins, content delivery networks, etc.).

### SUMMARY

The present disclosure describes a system for executing test suites. According to an embodiment, a computer system includes one or more memories and one or more processors communicatively coupled to the one or more memories. The one or more processors, individually or collectively, perform an operation that includes transmitting a message to a server and receiving, from the server, a response to the message. The operation also includes determining, by analyzing the response using a machine learning model, that a platform is unused by the server and based on the platform is unused, executing, against the server, a test suite except a portion of the test suite for the platform.

The operation may include determining, by analyzing the response using the machine learning model, that at least one of a service, a plugin, or a content delivery network are unused by the server and based on at least one of the service, the plugin, or the content delivery network being unused, executing the test suite may include executing the test suite except a portion of the test suite for at least one of the service, the plugin, or the content delivery network.

Analyzing the response may include generating a prompt based on the response and directing the prompt to the machine learning model.

The operation may include determining, by analyzing the response using the machine learning model, a confidence level that the platform is unused. The operation may include determining an explanation for the confidence level. The explanation may include a portion of the response.

The operation may include providing the machine learning model a plurality of platform options and The platform may be determined from the plurality of platform options.

The operation may include detecting a security risk in the server based on executing the test suite against the server.

According to another embodiment, a method includes transmitting a message to a server and receiving, from the server, a response to the message. The method may also include determining, by analyzing the response using a machine learning model, that a platform is unused by the server and based on the platform is unused, executing, against the server, a test suite except a portion of the test suite for the platform.

The method may include determining, by analyzing the response using the machine learning model, that at least one of a service, a plugin, or a content delivery network are unused by the server and, based on at least one of the service, the plugin, or the content delivery network being unused, executing the test suite may include executing the test suite except a portion of the test suite for at least one of the service, the plugin, or the content delivery network.

Analyzing the response may include generating a prompt based on the response and directing the prompt to the machine learning model.

The method may include determining, by analyzing the response using the machine learning model, a confidence level that the platform is unused. The method may include determining an explanation for the confidence level. The explanation may include a portion of the response.

The method may include providing the machine learning model a plurality of platform options and the platform may be determined from the plurality of platform options.

The method may include detecting a security risk in the server based on executing the test suite against the server.

According to another embodiment, a non-transitory computer readable medium stores instructions that, when executed by one or more processors, cause the one or more processors to, individually or collectively, perform an operation that includes transmitting a message to a server and receiving, from the server, a response to the message. The operation also includes determining, by analyzing the response using a machine learning model, that a platform is unused by the server and based on the platform being unused, executing, against the server, a test suite except a portion of the test suite for the platform.

The operation may include determining, by analyzing the response using the machine learning model, that at least one of a service, a plugin, or a content delivery network are unused by the server and, based on at least one of the service, the plugin, or the content delivery network being unused, executing the test suite may include executing the test suite except a portion of the test suite for at least one of the service, the plugin, or the content delivery network.

Analyzing the response may include generating a prompt based on the response and directing the prompt to the machine learning model.

The operation may include determining, by analyzing the response using the machine learning model, a confidence level that the platform is unused.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example system for determining a security risk.

FIG. 2 illustrates an example operation for generating a server response performed by the system of FIG. 1.

FIG. 3 illustrates an example operation for determining an unused system performed by the system of FIG. 1.

FIG. 4 illustrates an example operation for executing a test suite performed by the system of FIG. 1.

FIG. 5 illustrates an example operation for determining an unused system performed by the system of FIG. 1.

FIG. 6 is a flowchart of an example method for determining a security risk performed by the system of FIG. 1.

FIG. 7 depicts a diagram of an example computer system in which embodiments of the present disclosure may operate.

### DETAILED DESCRIPTION

Aspects of the present disclosure relate to the execution of a test suite against a server. One technique used to detect security risks presented by a server (e.g., a web server) is to execute a test suite against the server. The test suite may send different messages, including malformed or unexpected messages, to the server to simulate attacks against the server. The server's response to these simulated attacks may reveal whether the server is susceptible to or exposes certain security risks.

Existing test suites may include portions that target specific systems that the server may implement. For example, the test suites may include portions that target specific platforms, services, plugins, content delivery networks, etc. These test suites, however, may be executed against the server without regard for the systems that are not used or not implemented by the server. As a result, even if the server does not use a particular system, the portion of the test suites targeting that system may still be executed against the server, which produces irrelevant or erroneous results that may be interpreted incorrectly. Thus, executing the test suites wastes processing resources and may detect fake or false security risks that do not exist in the server.

The present disclosure describes a computer system that uses artificial intelligence to determine systems that are not implemented or used by a server based on responses from the server. The computer system may communicate a message to the server to elicit a response from the server. The computer system then uses artificial intelligence to analyze the response to determine whether the server does not use certain systems. For example, the computer system may determine whether certain platforms are unused by the server. If the computer system determines that a particular system is unused by the server, then the computer system may exclude a portion of a test suite targeting that system from execution when the test suite is executed against the server. The computer system may then execute the test suite except portions that have been excluded to determine a security risk exposed by the server.

In certain embodiments, the computer system presents several technical advantages. For example, the computer system may reduce the number of tests that are executed against a server, which may reduce the amount of time and processing resources used to test the server. As another example, the computer system may reduce the number of irrelevant or erroneous test results caused by executing tests against systems that are not implemented or unused by the server.

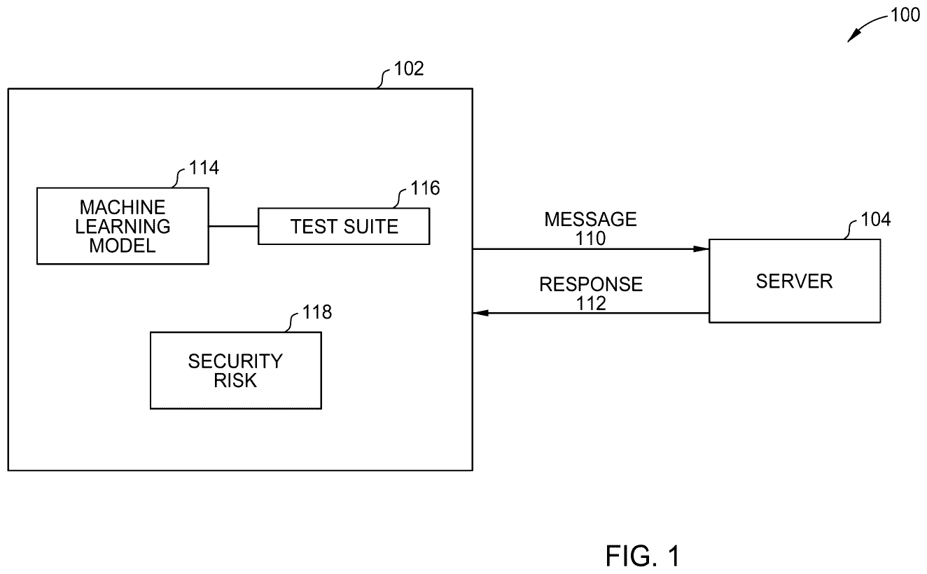

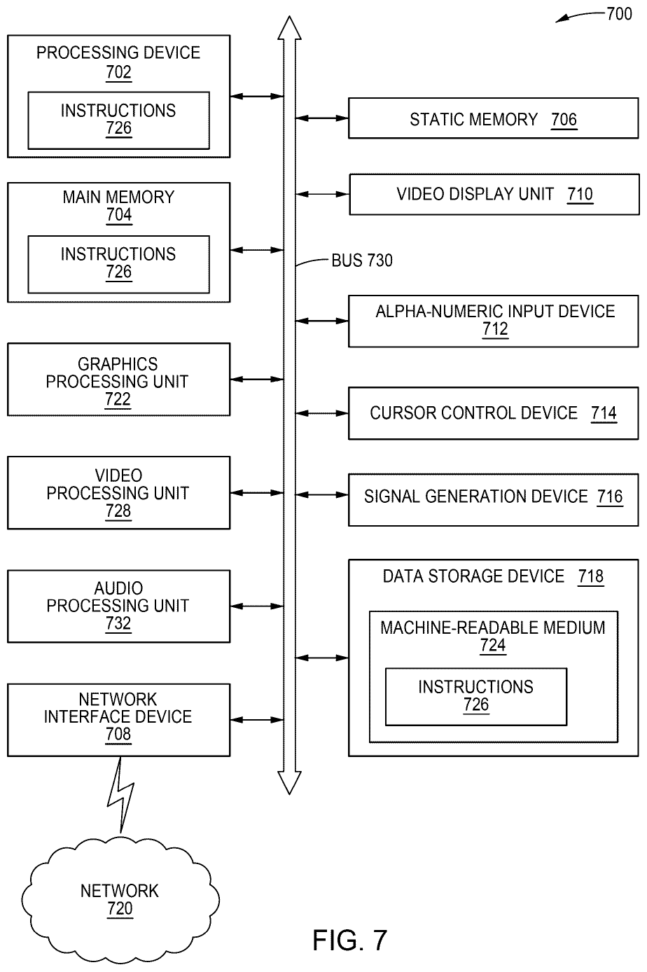

FIG. 1 illustrates an example system 100 for determining a security risk. As seen in FIG. 1, the system 100 includes a computer system 102 (which may be the computer system 700 shown in FIG. 7) and a server 104. Generally, the computer system 102 executes a test suite against the server 104 to determine or detect security risks in or presented by the server 104. The computer system 102 may use artificial intelligence to determine systems (e.g., platforms, services, plugins, content delivery networks (CDNs)) that are not implemented or used by the server 104. The computer system 102 may then refrain from executing portions of the test suite for these systems.

The computer system 102 may include any number of computers that execute tests against the server 104 to detect security risks in or presented by the server 104. The server 104 may include any number of computers that implement or provide a service. For example, the server 104 may be a webserver that hosts or provides a website. As another example, the server 104 may be a fileserver or application server that provides access to files or applications.

In operation, the computer system communicates a message 110 to the server 104 to cause the server 104 to communicate a response 112 back to the computer system 102. For example, if the server 104 hosts a website, the message 110 may request the server to communicate some of the contents of the website to the computer system 102. The response 112 may include some of the contents of the website. As another example, if the server 104 hosts files, the message 110 may request the server to retrieve a file. The response 112 may include some of the retrieved file.

The response 112 may also include information about the systems implemented by the server 104. For example, the response 112 may include code, comments, links, tags, etc. that suggest platforms, services, plugins, CDNs, etc. used or implemented by the server 104. Existing computer systems and/or testing systems, however, cannot use the information in the response 112 to determine the systems that are used and/or unused by the server 104.

The computer system 102 uses artificial intelligence to analyze the information in the response 112 to determine systems that are used and/or unused by the server 104. In the example of FIG. 1, the computer system 102 uses a machine learning model 114 to analyze the response 112 to determine systems that are used and/or unused by the server 104. The machine learning model 114 may be trained to determine from certain code, comments, links, tags, and/or combinations of code, comments, links, or tags in the response 112 the systems that are used and/or unused by the server 104. The computer system 102 may generate a prompt using the information in the response 112 and direct the prompt to the machine learning model 114. The machine learning model 114 may then determine the systems that are used and/or unused by the server 104 from the prompt.

The computer system 102 then determines portions of a test suite 116 that should be executed or not executed based on the systems that are used and/or unused by the server 104. For example, if the computer system 102 determines that a system is used by the server 104, then the computer system 102 may execute a portion of the test suite 116 for that system. On the other hand, if the computer system 102 determines that a system is unused by the server 104, then the computer system 102 may not execute a portion of the test suite 116 for that system. In this manner, the computer system 102 may refrain from executing portions of the test suite 116 that test systems that are unused by the server 104, which reduces the amount of time it takes to execute the test suite 116 against the server 104 and which may reduce the number of false positives.

The test suite 116 may include portions that test different systems. When executing a portion of the test suite 116, the computer system 102 may simulate attacks against a particular system used by the server 104. For example, the computer system 102 may direct malformed, mistimed, or null messages to the server 104 to elicit a response from the server 104. If the server 104 does not handle the malformed, mistimed, or null messages appropriately, then the malformed, mistimed, or null messages may expose a security risk in the server 104. For example, the portion of the test suite 116 may reveal that the malformed, mistimed, or null messages may cause the server 104 to behave unexpectedly or inappropriately, which may be a security risk or vulnerability for the server 104.

By executing the portions of the test suite 116 for the systems used by the server 104, the computer system 102 may determine one or more security risks 118 in the server 104. The computer system 102 may then report these security risks 118, and remedial action may be taken to remove or resolve these security risks 118. For example, software code in the server 104 may be adjusted to remove or resolve these security risks 118.

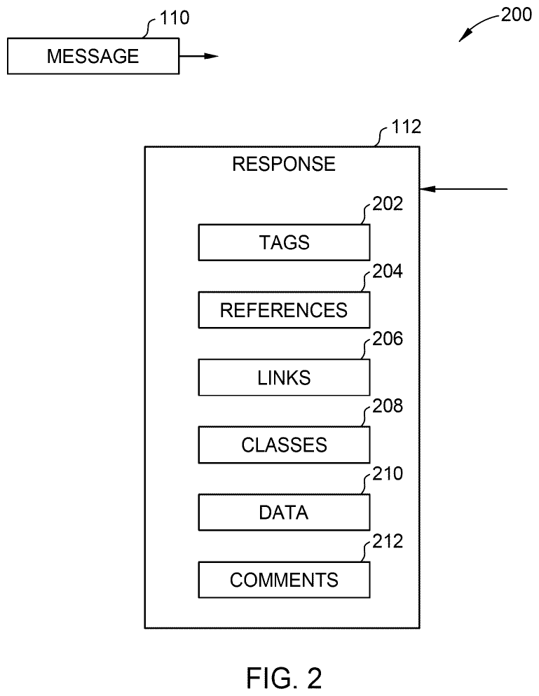

FIG. 2 illustrates an example operation 200 for generating a server response performed by the system 100 of FIG. 1. Generally, a computer system (e.g., the computer system 700 shown in FIG. 7) performs the operation 200. By performing the operation 200, the computer system elicits a response from a server (e.g., the server 104 shown in FIG. 1).

The computer system begins by communicating the message 110 to the server. The message 110 may request that the server perform an operation or task. For example, the message 110 may request that the server adjust a website, store a file, or perform an operation in an application. As another example, the message 110 may request information from the server. The message 110 may request a website hosted by the server. The message 110 may request an application or file hosted by the server. The message 110 may include any information that the server may use to retrieve information for the computer system. For example, the message 110 may identify the computer system, the server, a user of the computer system and/or server, the information to be retrieved (e.g., a website, application, file, etc.), and/or the operation or task to be performed. The message 110 may also include arguments, parameters, or other information that the server may use to perform the requested task or operation.

The server may receive the message 110 from the server and perform the requested task or operation. For example, the server may retrieve a requested website, application, or file. As another example, the server may perform a task or operation in a website or application. The server may generate and communicate a response 112 back to the computer system as part of performing the task or operation. The response 112 may include information from the server that indicates the results of the task or operation. The response 112 may also include additional information from the server that provides context for the task or operation.

In the example of FIG. 2, the response 112 includes one or more tags 202, one or more references 204, one or more links 206, one or more classes 208, data 210, and/or one or more comments 212. The tags 202, references 204, links 206, classes 208, data 210, and/or comments 212 may provide information and/or context. The tags 202 may indicate describe the functions of and relationships between elements in the data 210. The references 204, links 206, and/or classes 208 may indicate directories, file locations, websites, etc. accessed by the server to perform the task or operation. The data 210 may include website data, application data, file data, etc. that the server communicates back to the computer system. The comments 212 may include machine or human generated text that provides additional information or context for the task or operation. The computer system may analyze the information in the response 112 to determines systems that the server uses and/or does not use.

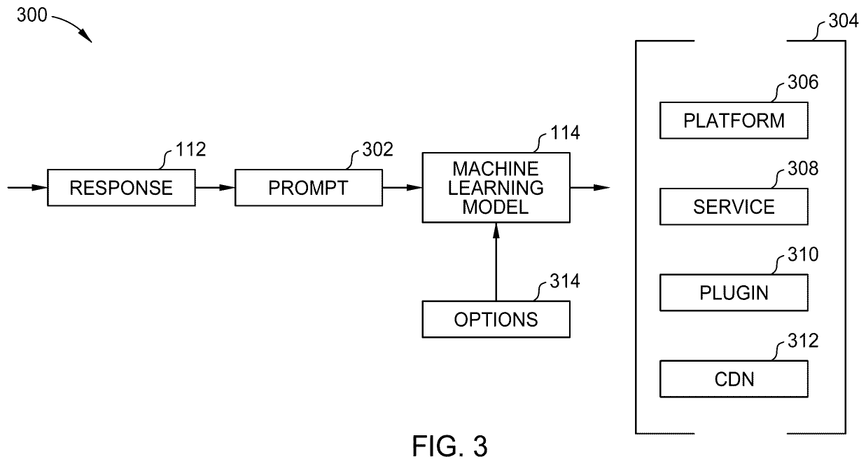

FIG. 3 illustrates an example operation 300 for determining an unused system performed by the system 100 of FIG. 1. Generally, a computer system (e.g., the computer system 700 shown in FIG. 7) performs the operation 300. By performing the operation 300, the computer system uses artificial intelligence to determine systems that are used or unused by a server (e.g., the server 104 shown in FIG. 1).

The computer system receives the response 112 from the server. As discussed previously, the response 112 may include information related to the performance of an operation or task. The computer system analyzes the response 112 to determine the systems used or unused by the server. The computer system may begin by generating a prompt 302 using the information in the response 112. For example, the prompt 302 may request the machine learning model 114 to determine the systems that the server uses and/or does not use based on the information that the server included or did not include in the response 112. The prompt 302 may also include the information in the response 112 (e.g., the tags, references, links, classes, data, comments, etc.).

The computer system directs the prompt 302 to the machine learning model 114, and the machine learning model 114 analyzes the prompt 302 to determine the systems 304 that are used and/or unused by the server. The machine learning model 114 may be any artificial intelligence model that generates responses or predictions based on supplied input. For example, the machine learning model 114 may include a neural network and/or a large language model that responds to the prompt 302 by determining one or more systems 304 that are used or unused by the server.

The machine learning model 114 may be trained to detect certain information (e.g., tags, references, links, classes, data, comments, etc.) in the prompt 302 and to determine systems that are used or unused by the server based on that information. In the example of FIG. 3, the machine learning model 114 uses the information in the prompt 302 to determine a platform 306, a service 308, a plugin 310, and/or a CDN 312 that are used and/or unused by the server. For example, the machine learning model 114 may determine that the server uses or does not use a content management system, server-side language, theme, libraries, application programming interfaces (APIs), protocols, meta tags, optimizations, icons, stylings, accessibility options, standards, etc. Examples of platform 306 may include Wordpress, Hypertext Processor, ActiveServer Pages, WebSphere, etc. Examples of CDNs 312 may include Cloudflare. Examples of other systems include Internet Information Services and Apache.

In some embodiments, the computer system may provide the machine learning model 114 a set of options 314, and the machine learning model 114 may determine or select the systems 304 that are used or unused by the server from the set of options 314. For example, the computer system may incorporate the set of options 314 in the prompt 302, and the options 314 may be directed to the machine learning model 114 when the prompt 302 is directed to the machine learning model 114. The set of options 314 may include platform options, service options, plugin options, CDN options, etc. The machine learning model 114 may check whether each of the options 314 are used or unused by the server when analyzing the information in the prompt 302.

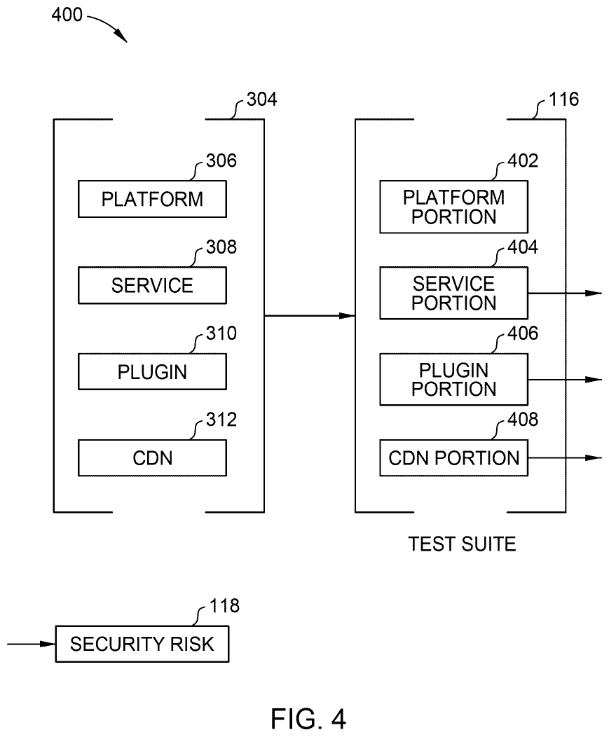

FIG. 4 illustrates an example operation 400 for executing a test suite performed by the system 100 of FIG. 1. Generally, a computer system (e.g., the computer system 700 shown in FIG. 7) performs the operation 400. By performing the operation 400, the computer system detects or determines a security risk exposed by a server (e.g., the server 104 shown in FIG. 1).

The computer system begins with the determined systems 304 that are used or unused by the server. For example, the computer system may have used artificial intelligence to determine the platforms 306, services 308, plugins 310, CDNs 312, etc. that are used or unused by the server. The computer system then determines portions of the test suite 116 to be executed or not executed against the server using the determined systems 304. As seen in FIG. 4, the test suite 116 includes various portions that simulate attacks against different systems. For example, the test suite 116 may include a platform portion 402 that simulates attacks against a particular platform, a service portion 404 that simulates attacks against a particular service, a plugin portion that simulates attacks against a particular plugin, and a CDN portion that simulates attacks against a particular CDN. The test suite 116 may include any number of portions that simulate attacks against any system (e.g., content management system, server-side language, theme, libraries, application programming interfaces (APIs), protocols, meta tags, optimizations, icons, stylings, accessibility options, standards, etc.).

If the computer system determines that a particular system 304 is unused by the server, then the computer system may exclude the portion of the test suite 116 that simulates attacks against that particular system 304 when executing the test suite 116. Conversely, if the computer system determines that a particular system 304 is used by the server, then the computer system may include the portion of the test suite 116 that simulates attacks against that particular system 304 when executing the test suite 116.

In the example of FIG. 4, the computer system may have determined that the server is using the service 308, the plugin 310, and the CDN 312. The computer system may also have determined that the server is not using the platform 306. In response, the computer system includes the service portion 404 for the service 308, the plugin portion 406 for the plugin 310, and the CDN portion 408 for the CDN 312 when executing the test suite 116. Additionally, the computer system excludes the platform portion 402 for the platform 306. As a result, when executing the test suite 116, the computer system may execute the service portion 404, the plugin portion 406, and the CDN portion 408, and the computer system may refrain from executing the platform portion 402. As a result, it may take less time to execute the test suite 116, and the computer system may avoid generating false positives that result from executing the platform portion 402 against the server.

The computer system may determine a security risk 118 exposed by the server by executing the test suite 116 against the server. For example, by executing the service portion 404 of the test suite 116 against the server, the computer system simulates attacks against the service 308 used by the server. The server may respond inappropriately or improperly to the attacks, which may indicate the security risk 118 exposed by the server. After determining the security risk 118, the computer system may adjust the server to remedy or resolve the security risk 118. For example, the server may update a service, plugin, or CDN. As another example, server code may be adjusted. In this manner, the computer system detects and resolves security risks 118 exposed by the server, which may improve the security of the server.

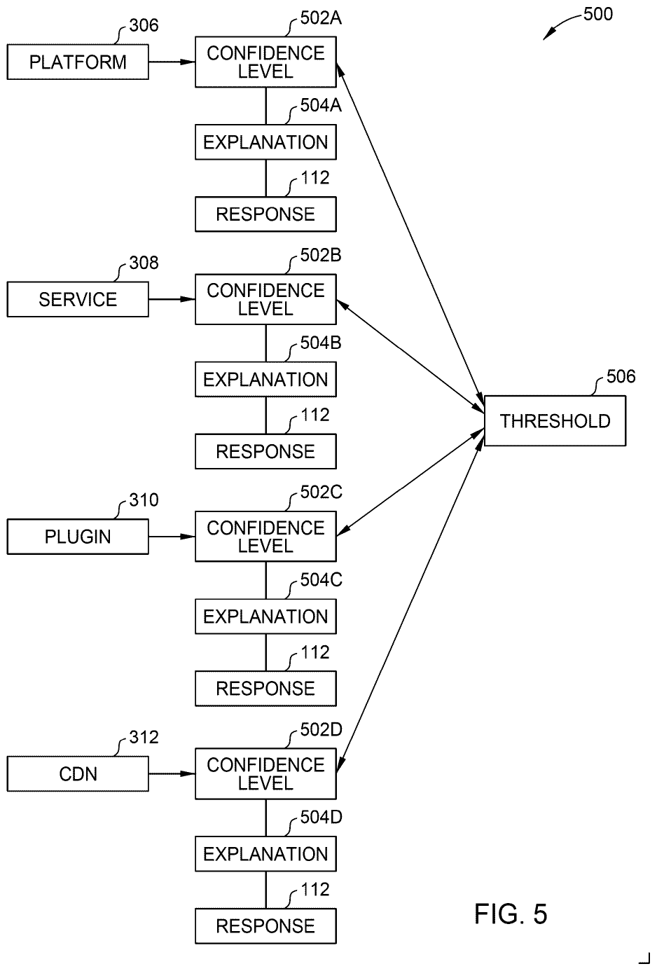

FIG. 5 illustrates an example operation 500 for determining an unused system performed by the system 100 of FIG. 1. Generally, a computer system (e.g., the computer system 700 shown in FIG. 7) performs the operation 500. By performing the operation 500, the computer system determines systems that are used or unused by a server (e.g., the server 104 shown in FIG. 1).

In some instances, the determination whether a particular system is used or unused by the server is not necessarily binary. Instead, the computer system may determine (e.g., using artificial intelligence) a probability or chance that the server uses or does not use a particular system. The computer system may then compare that probability or chance against a threshold to determine whether the computer system should treat the server as using or not using the particular system.

In the example of FIG. 5, for each potential system, the computer system may determine a confidence level 502 that the server uses or does not use the system. For the platform 306, the computer system determines a confidence level 502A that the server uses or does not use the platform 306. For the service 308, the computer system determines a confidence level 502B that the server uses or does not use the service 308. For the plugin 310, the computer system determines a confidence level 502C that the server uses or does not use the plugin 310. For the CDN 312, the computer system determines a confidence level 502D that the server uses or does not use the CDN 312.

The computer system may compare each of the confidence levels 502 against a threshold 506 to determine whether the computer system should treat a particular system as used or unused. For example, if a confidence level 502 indicates a probability or chance that a system is unused by the server and the confidence level 502 exceeds the threshold 506, then the computer system may determine that the system is unused by the server. Conversely, if the confidence level 502 does not exceed the threshold 506, then the computer system may determine that the system is used by the server. As another example, if the confidence level 502 indicates a probability or chance that a system is used by the server and the confidence level 502 exceeds the threshold 506, then the computer system may determine that the system used by the server. Conversely, if the confidence level 502 does not exceed the threshold 506, then the computer system may determine that the system is unused by the server.

In the example of FIG. 5, the computer system compares the confidence levels 502A, 502B, 502C, and 502D against the threshold 506 to determine whether the platform 306, the service 308, the plugin 310, and the CDN 312 are used or unused by the server. If the confidence levels 502A, 502B, 502C, and 502D indicate probabilities or chances that the platform 306, the service 308, the plugin 310, and the CDN 312 are unused by the server, then the computer system may determine that the platform 306, the service 308, the plugin 310, or the CDN 312 are unused by the server if the confidence levels 502A, 502B, 502C, or 502D exceed the threshold 506. The computer system may determine that the platform 306, the service 308, the plugin 310, or the CDN 312 are used by the server if the confidence levels 502A, 502B, 502C, or 502D fall below the threshold 506. Likewise, if the confidence levels 502A, 502B, 502C, and 502D indicate probabilities or chances that the platform 306, the service 308, the plugin 310, and the CDN 312 are used by the server, then the computer system may determine that the platform 306, the service 308, the plugin 310, or the CDN 312 are used by the server if the confidence levels 502A, 502B, 502C, or 502D exceed the threshold 506. The computer system may determine that the platform 306, the service 308, the plugin 310, or the CDN 312 are unused by the server if the confidence levels 502A, 502B, 502C, or 502D fall below the threshold 506.

In some embodiments, the computer system may also determine (e.g., using artificial intelligence) an explanation 504 for each confidence level 502. The explanation 504 may provide reasons why a confidence level 502 is a certain value. For example, the explanation 504 may include portions of the response 112 that the machine learning model used to determine whether the server used or did not use the system for that confidence level 502. The explanation may include the tags, references, links, classes, data, comments, etc. from the response 112. A user or operator of the computer system may review the explanation to verify the determinations of the machine learning model.

In the example of FIG. 5, the computer system determines the explanation 504A to explain the confidence level 502A for the platform 306. The computer system determines the explanation 504B for the confidence level 502B for the service 308. The computer system determines the explanation 504C for the confidence level 502C for the plugin 310. The computer system determines the explanation 504D for the confidence level 502D for the CDN 312. Each of the explanations 504A, 504B, 504C, and 504D may include a portion of the response 112 from the server. The computer system may determine any number of confidence levels 502 and/or explanations 504 for any number of systems.

As an example, the computer system may determine a confidence level of 99% that the server uses a content management system (e.g., WordPress) based on information in the response. The explanation may include information from the response as evidence for use of the content management system. For example, the explanation may indicate that the response includes a meta generator tag <meta name=“generator” content=“CMS 6.7-alpha-59049”/>. As another example, the explanation may indicate that the response includes uniform resource locators or directories that are specific to the content management system such as references to /wp/xmlrpc.php and /wp-json/ and such as uniform resource locators https://site.me/wp/wp-includes/js/jquery.min.js. As another example, the explanation may indicate that the response includes body classes such as <body class=“home page-template page-template-templates page-template-homepage page-templateshomepage-php page page-id-5”>.

As another example, the computer system may determine a confidence level of 95% that the server uses a server-side language (e.g., Hypertext Processor) based on information in the response. The explanation may include information from the response as evidence for use of the server-side language. For example, the explanation may indicate that a content management system used by server uses a particular server-side language.

As another example, the computer system may determine a confidence level of 95% that the server uses a theme (e.g., underscores starter theme) based on information in the response. The explanation may include information from the response as evidence for use of the theme. For example, the explanation may indicate that the response includes a page title <title> Site|A starter theme </title> and/or a stylesheet <link rel=‘stylesheet’ id=‘style-css’ href=‘https://site.me/content/themes/site-github/style.css’ type=‘text/css’ media=‘all’/>. As another example, the explanation may indicate that the response includes content references such as <h1> Secure your software supply chain </h1> and other structured markup.

As another example, the computer system may determine a confidence level of 80% that the server uses a plugin (e.g., MonsterInsights) based on information in the response. The explanation may include information from the response as evidence for use of the theme. For example, the explanation may indicate that the response includes a comment <!—This site uses the analytics plugin v8.9.1—Using Analytics tracking—https://www.site.com/--> and/or a comment <!—Note: Plugin is not currently configured on this site. The site owner needs to authenticate in the settings panel.-->.

As another example, the computer system may determine a confidence level of 99% that the server uses a library (e.g., JavaScript) based on information in the response. The explanation may include information from the response as evidence for use of the library. For example, the explanation may indicate that the response includes a query inclusion <script type=“text/javascript” src=https://site.me/wp/wp-includes/js/jquery/jquery.min.js id=“jquery-core-js”></script>.

As another example, the computer system may determine a confidence level of 90% that the server uses a service (e.g., Typekit) based on information in the response. The explanation may include information from the response as evidence for use of the service. For example, the explanation may indicate that the response includes a script <script type=“text/javascript” src=“//use.kit.net/qcr7ewy.js”</script> <script type=“text/javascript”> try{kit.load( );]catch(e){ }</script>.

As another example, the computer system may determine a confidence level of 95% that the server uses an API (e.g., Rest API) based on information in the response. The explanation may include information from the response as evidence for use of the API. For example, the explanation may indicate that the response includes a link <link rel=“https://api.site.org/” href=“https://site.me/wp-json/”/>.

As another example, the computer system may determine a confidence level of 90% that the server uses a protocol (e.g., Endpoint) based on information in the response. The explanation may include information from the response as evidence for use of the protocol. For example, the explanation may indicate that the response includes a link <link rel=“pingback” href=“https://site.me/wp/xmlrpc.php”/>.

As another example, the computer system may determine a confidence level of 90% that the server uses a meta tag (e.g., Open Graph or Twitter) based on information in the response. The explanation may include information from the response as evidence for use of the meta tag. For example, the explanation may indicate that the response includes tags <meta property=“og:title” content=“site”/> and <meta property=“og:description” content=“A Starter Theme”/> <meta name=“site: card” content=“summary”/>. As another example, the explanation may indicate that the response includes links <link rel=canonical” href=“https://site.me/”/> <link rel=“alternate” title=“oEmbed (JSON)” type=“application/json+oembed” href=“https://site.me/wp-json/oembed/1.0/embed”/>.

As another example, the computer system may determine a confidence level of 90% that the server uses an icon (e.g., Favicon) based on information in the response. The explanation may include information from the response as evidence for use of the icon. For example, the explanation may indicate that the response includes a link <link rel=“shortcut icon” href=https://site.me/content/themes/site-github/icon.ico”/> and <link rel=“touch-icon” href=“https://site.me/content/themes/site-github/purple.png”/>.

As another example, the computer system may determine a confidence level of 90% that the server uses a style or stylesheet based on information in the response. The explanation may include information from the response as evidence for use of the style or stylesheet. For example, the explanation may indicate that the response includes multiple <style> tags and links to external style files.

As another example, the computer system may determine a confidence level of 85% that the server uses an accessibility option or standard based on information in the response. The explanation may include information from the response as evidence for use of the accessibility option or standard. For example, the explanation may indicate that the response includes certain HTML heading tags (e.g., <h1>, <h2>, etc.) or attributes. As another example, the explanation may indicate that the response includes a viewport tag and/or responsive classes (e.g., col-xs-12, col-sm-6, etc.).

In some embodiments, the computer system further provides a summary of the determinations. The summary may indicate the systems used or unused by the server along with confidence levels.

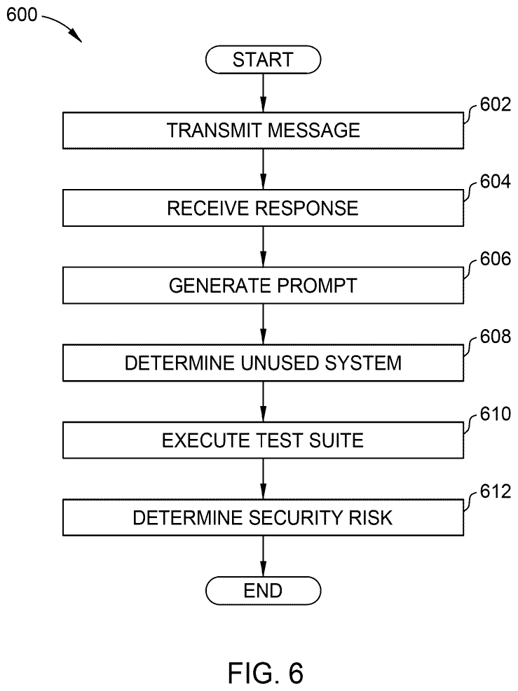

FIG. 6 is a flowchart of an example method 600 for determining a security risk performed by the system of FIG. 1. In particular embodiments, a computer system (e.g., the computer system 700 shown in FIG. 7) performs the method 600. By performing the method 600, the computer system uses artificial intelligence to determine which portions of a test suite should be executed or not executed against a server to determine security risks exposed by the server.

At 602, the computer system transmits a message to the server. The message may be a request intended to elicit a response from the server. For example, the message may request that the server perform an operation or a task (e.g., retrieve a website, application, or file or perform an operation in a website or application). After receiving the message, the server may perform the requested task or operation.

At 604, the computer system receives the response from the server. The response may include the results of performing the task or operation. Additionally, the response may include information about the server that provides context for performing the task or operation. For example, the response may include tags, references, links, classes, data, or comments from the server.

At 606, the computer system generates a prompt using the information in the response from the server. The prompt may request a machine learning model to determine whether the server uses or does not use certain systems based on the information in the response. The computer system may direct the prompt to the machine learning model.

At 608, the computer system determines an unused system. For example, the machine learning model may determine that the information in the response indicates that a system is not used by the server. As another example, the machine learning model may determine that the information in the response indicates a probability or chance that the server does not use the system. The computer system may then determine that the probability or chance exceeds a threshold and determine that the computer system should treat the system as unused by the server.

The machine learning model may determine whether any system is used or unused by the server. For example, the machine learning model may determine whether the server uses certain platforms, services, plugins, or CDNs. The machine learning model may determine whether the server uses certain content management systems, server-side languages, themes, libraries, APIs, protocols, meta tags, optimizations, icons, stylings, accessibility options, standards, etc.

At 610, the computer system executes a test suite against the server. The test suite may include portions that simulate attacks against particular systems. If the computer system determines that the server is using a particular system, then the computer system may include the portion of the test suite that simulates attacks against that system when executing the test suite. If the computer system determines that the server is not using a particular system, then the computer system may exclude the portion of the test suite that simulates attacks against that system when executing the test suite. In this manner, the computer system excludes portions of the test suite so that those portions are not executed, which reduces the amount of time it takes to execute the test suite.

At 612, the computer system determines a security risk through executing the test suite. The executed portions of the test suite may simulate attacks against certain systems on the server. If the server responds inappropriately or improperly to an attack, then the computer system may determine that a security risk is exposed by the server. The computer system may then adjust the server (e.g., server code, server applications, server platforms, server plugins, etc.) to resolve the security risk.

FIG. 7 illustrates an example machine of a computer system 700 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM), a static memory 706 (e.g., flash memory, static random access memory (SRAM), etc.), and a data storage device 718, which communicate with each other via a bus 730.

Processing device 702 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 may be configured to execute instructions 726 for performing the operations and steps described herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a non-transitory computer-readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In some implementations, the instructions 726 include instructions to implement functionality corresponding to the present disclosure. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 702 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A computer system for testing a server, the computer system comprising:
one or more memories; and
one or more processors communicatively coupled to the one or more memories, the one or more processors configured to, individually or collectively, perform an operation comprising:
transmitting a message to a server;
receiving, from the server, a response to the message;
determining, by analyzing the response using a machine learning model, that a platform is unused by the server; and
based on the platform is unused, executing, against the server, a test suite except a portion of the test suite for the platform.

2. The computer system of claim 1, wherein the operation further comprises determining, by analyzing the response using the machine learning model, that at least one of a service, a plugin, or a content delivery network are unused by the server and wherein, based on at least one of the service, the plugin, or the content delivery network being unused, executing the test suite comprises executing the test suite except a portion of the test suite for at least one of the service, the plugin, or the content delivery network.

3. The computer system of claim 1, wherein analyzing the response comprises:
generating a prompt based on the response; and
directing the prompt to the machine learning model.

4. The computer system of claim 1, wherein the operation further comprises determining, by analyzing the response using the machine learning model, a confidence level that the platform is unused.

5. The computer system of claim 4, wherein the operation further comprises determining an explanation for the confidence level.

6. The computer system of claim 5, wherein the explanation comprises a portion of the response.

7. The computer system of claim 1, wherein the operation further comprises providing the machine learning model a plurality of platform options and wherein the platform is determined from the plurality of platform options.

8. The computer system of claim 1, wherein the operation further comprises detecting a security risk in the server based on executing the test suite against the server.

9. A method for testing a server, the method comprising:
transmitting a message to a server;
receiving, from the server, a response to the message;
determining, by analyzing the response using a machine learning model, that a platform is unused by the server; and
based on the platform is unused, executing, against the server, a test suite except a portion of the test suite for the platform.

10. The method of claim 9, further comprising determining, by analyzing the response using the machine learning model, that at least one of a service, a plugin, or a content delivery network are unused by the server and wherein, based on at least one of the service, the plugin, or the content delivery network being unused, executing the test suite comprises executing the test suite except a portion of the test suite for at least one of the service, the plugin, or the content delivery network.

11. The method of claim 9, wherein analyzing the response comprises:
generating a prompt based on the response; and
directing the prompt to the machine learning model.

12. The method of claim 9, further comprising determining, by analyzing the response using the machine learning model, a confidence level that the platform is unused.

13. The method of claim 12, further comprising determining an explanation for the confidence level.

14. The method of claim 13, wherein the explanation comprises a portion of the response.

15. The method of claim 9, further comprising providing the machine learning model a plurality of platform options and wherein the platform is determined from the plurality of platform options.

16. The method of claim 9, further comprising detecting a security risk in the server based on executing the test suite against the server.

17. A non-transitory computer readable medium storing instructions for testing a server that, when executed by one or more processors, cause the one or more processors to, individually or collectively, perform an operation comprising:
transmitting a message to a server;
receiving, from the server, a response to the message;
determining, by analyzing the response using a machine learning model, that a platform is unused by the server; and
based on the platform being unused, executing, against the server, a test suite except a portion of the test suite for the platform.

18. The medium of claim 17, wherein the operation further comprises determining, by analyzing the response using the machine learning model, that at least one of a service, a plugin, or a content delivery network are unused by the server and wherein, based on at least one of the service, the plugin, or the content delivery network being unused, executing the test suite comprises executing the test suite except a portion of the test suite for at least one of the service, the plugin, or the content delivery network.

19. The medium of claim 17, wherein analyzing the response comprises:
generating a prompt based on the response; and
directing the prompt to the machine learning model.

20. The medium of claim 17, wherein the operation further comprises determining, by analyzing the response using the machine learning model, a confidence level that the platform is unused.
